(19) United States
(12) Patent Application Publication
(10) Pub. No.: US 2018/0071703 A1
(43) Pub. Date: Mar. 15, 2018

(54) COMPACT COMBINED MIXING AND DISTRIBUTION DEVICE

(71) Applicant: IFP Energies Nouvelles, Rueil-Malmaison Cedex (FR)

(72) Inventors: Philippe BEARD, Saint Genis-Laval (FR); Frederic BAZER-BACHI, Irigny (FR); Cecile PLAIS, Les Haies (FR); Frederic AUGIER, Saint Symphorien D Ozon (FR); Yacine HAROUN, Lyon (FR)

(73) Assignee: IFP Energies Nouvelles, Rueil-Malmaison Cedex (FR)

(21) Appl. No.: 15/563,116

(22) PCT Filed: Feb. 16, 2016
(86) PCT No.: PCT/EP2016/053290

§ 371 Date: Sep. 29, 2017

(30) Foreign Application Priority Data
Apr. 1, 2015 (FR) 15-52785

(51) Int. Cl. B01J 8/04

(52) U.S. Cl. CPC B01J 8/0453; B01J 8/0492

(57) ABSTRACT

A device for mixing and distributing fluids for a downward flow catalytic reactor, said device comprising:
a collection zone comprising at least one collection means;
at least one substantially vertical collection conduit adapted to receive a reaction fluid collected by said collection means and at least one injection means;
a mixing zone; and
a distribution zone comprising a distribution plate supporting a plurality of chimneys;
characterised in that said mixing zone is disposed at the same level as the distribution zone, said mixing and distribution zones being delimited by at least one annular wall comprising at least one lateral passage section adapted for the passage of the fluids from said mixing zone to said distribution zone.

### TECHNICAL FIELD

The present invention is applied in the field of exothermic reactions and more particularly to hydrotreatment, hydrodesulphurisation, hydrodenitrification, hydrocracking, hydrogenation, hydrodeoxygenation or again hydrodearomatisation reactions which are carried out in a fixed bed reactor. The invention more particularly concerns a device for mixing and distributing fluids in a downward flow reactor and use thereof for the implementation of exothermic reactions.

### STATE OF THE ART

Exothermic reactions which are carried out for example in refining and/or petrochemicals need to be cooled by an additional fluid, referred to as a quench fluid, to avoid thermal runaway of the catalytic reactor in which they are carried out. The catalytic reactors used for those reactions generally comprise at least one solid catalyst bed. The exothermic character of the reactions makes it necessary to maintain a homogeneous temperature gradient within the reactor in order to avoid the existence of hot spots in the catalyst bed in the reactor. Excessively hot zones may prematurely reduce the activity of the catalyst and/or result in non-selective reactions and/or result in thermal runaway phenomena. It is therefore important to have at least one mixing chamber in the reactor, that is disposed between two catalyst beds, which permits homogeneous distribution in respect of temperature of the fluids over a reactor section and cooling of the reaction fluids to a desired temperature.

To perform that homogenisation operation the man skilled in the art is often lead to use a specific arrangement of internal items of equipment which are often complex involving an introduction of the quench fluid, in the most possible homogeneous fashion, in the section of the reactor. For example FR 2 824 495 A1 describes a quenching device which makes it possible to ensure effective exchange between the quench fluid or fluids and the fluid or fluids of the process. That device is integrated into a chamber and comprises an injection lance for the quench fluid, a baffle for collection of the fluids, the quenching box in the strict sense, implementing mixing as between the quench fluid and the downward flow, and a distribution system composed of a perforated bowl and a distribution plate. The quenching box comprises a deflector for implementing a turbulent movement of the fluids in a direction which is substantially non-radial and non-parallel to the axis of said chamber and downstream of the deflector in the direction of flow of the reaction fluid, at least one passage section for discharge of the mixture of fluids that is formed in the quenching box. That device makes it possible to remedy some disadvantages of the different systems in the prior art but it is still bulky.

To remedy the bulkiness problem a device for mixing fluids in a downward flow reactor has been developed and is described in FR 2 952 835 A1. That device comprises a horizontal collection means provided with a vertical collection conduit for receiving the fluids, an injection means disposed in the collection conduit and an annular mixing chamber of circular section disposed downstream of the collection means in the direction of flow of the fluids. The mixing chamber comprises an inlet end connected to the collection conduit and an outlet end permitting the fluids to flow therethrough, and a horizontal pre-distribution plate comprising at least one chimney. The advantage of that device is that it is more compact than that described hereinbefore and it makes it possible to ensure good mixing of the fluids and good temperature homogeneity.

An aim of the invention is to propose a mixing device and a distribution device for fluids, which are space-saving when they are placed in a catalytic reactor. Another aim of the present invention is to propose a mixing and distribution device affording good efficiency in respect of mixing fluids and affording good temperature homogeneity and good distribution.

The applicant has developed a combined fluid mixing and distribution device which makes it possible to significantly reduce the space dedicated to mixing and distribution of fluids in particular in a downward flow reactor.

### OBJECTS OF THE INVENTION

A first object of the invention concerns a device for mixing and distributing fluids for a downward flow catalytic reactor, said device comprising:
at least one collection zone (A) comprising at least one collection means;
at least one substantially vertical collection conduit adapted to receive a reaction fluid collected by said collection means and at least one injection means opening into said collection conduit to inject a quench fluid;
at least one mixing zone (B) disposed downstream of the collection means in the direction of flow of the fluids, said mixing zone (B) comprising at least one mixing chamber connected to said collection conduit and an outlet end for discharge of the fluids; and
at least one distribution zone (C) disposed downstream of said mixing zone (B) in the direction of flow of the fluids comprising a distribution plate supporting a plurality of chimneys s;
characterised in that said mixing zone (B) is disposed at the same level as the distribution one (C), said mixing zone (B) and said distribution zone (C) being delimited by at least one annular wall comprising at least one lateral passage section adapted for the passage of the fluids from said mixing zone (B) to said distribution zone (C).

Preferably said mixing zone (B) is included in an annular enclosure comprising said annular wall.

Advantageously said annular wall internally delimits said distribution zone (C).

Preferably said annular wall is positioned at a spacing d2 from the enclosure of the reactor, the spacing d2 varying from 2% to 20% of the diameter of the reactor.

Advantageously said mixing chamber is positioned at a spacing d1 from the enclosure of the reactor, the spacing d1 being between 5 and 30 mm.

Preferably the height of said annular enclosure is between 200 and 800 mm.

Advantageously the annular wall comprises a plurality of lateral passage sections distributed on at least two levels.

Preferably said annular wall is substantially cylindrical.

In an embodiment of the invention the section of said mixing chamber is of a parallelogram configuration and has a ratio between the height “h” of the section and the width “l” of said section of between 0.2 and 5.0.

In a particular embodiment of the invention said mixing zone (B) comprises two mixing chambers which are in diametrally opposite relationship in said mixing zone (B).

Advantageously the chimneys which are disposed at the periphery of said distribution zone (C) are prolonged below the distribution plate and are angled, the angling angle α between the longitudinal axis of prolongation of the chimneys below said distribution chamber and the plane perpendicular to the longitudinal axis of the enclosure being between 0 and 90 degrees.

Preferably the device according to the invention further comprises a dispersive system disposed below said distribution plate, said dispersive system comprising at least one dispersion device.

Advantageously said dispersion device is a grid comprising at least one guide system adapted to collect and transport at least a part of the flow of liquid issuing from said distribution zone (C).

Preferably said mixing and distribution zones (B and C) are delimited by two annular walls each comprising at least one lateral passage section adapted for the passage of the fluids from said mixing zone (B) to said distribution zone (C).

Another object of the invention concerns a downward flow catalytic reactor comprising an enclosure containing at least two fixed catalyst beds separated by an intermediate zone comprising a device for mixing and distribution of fluids according to the invention.

### DESCRIPTION OF THE FIGURES

FIG. 1 shows an axial section of a downward flow catalytic reactor comprising at least two solid catalyst beds and comprising a compact fluid mixing and distribution device according to the prior art. The bold arrow represents the direction of flow of the fluids in the reactor.

FIG. 2 shows an axial section of a downward flow catalytic reactor comprising at least two solid catalyst beds and comprising a compact fluid mixing and distribution device according to a variant of the invention. The bold arrow represents the direction of flow of the fluids in the reactor. The mixing chamber is not shown in FIG. 2 for the sake of clarity.

FIG. 3 shows a section of the compact fluid mixing and distribution device along the section represented by the dash-dotted line X-X′ in FIG. 2.

FIG. 4 shows an axial section of the mixing and distribution device shown in FIG. 2.

FIG. 5 is a perspective view of a part of the mixing and distribution device shown in FIG. 2.

FIGS. 6a, 6b and 6c show variants of the mixing and distribution device shown in FIG. 2.

FIG. 7 is a diagrammatic representation of a variant of the mixing and distribution device according to the invention.

### DETAILED DESCRIPTION OF THE INVENTION

The compact mixing and distribution device according to the invention is used in a reactor in which exothermic reactions are carried out such as hydrotreatment, hydrodesulphurisation, hydrodenitrification, hydrocracking, hydrogenation, hydrodeoxygenation or again hydrodearomatisation reactions. Generally the reactor is of an elongate shape along a substantially vertical axis. At least one reaction fluid (also referred to as the “process fluid” using the English terminology) is circulated from the top downwardly in the reactor through at least one fixed catalyst bed. Advantageously at the outlet from each bed except for the last the reaction fluid is collected and then mixed with a quench fluid (using the English terminology) in said device before being distributed to the catalyst bed disposed downstream of the distribution plate. Downstream and upstream are defined in relation to the direction of flow of the reaction fluid. The reaction fluid can be a gas or a liquid or a mixture containing liquid and gas; that depends on the type of reaction carried out in the reactor.

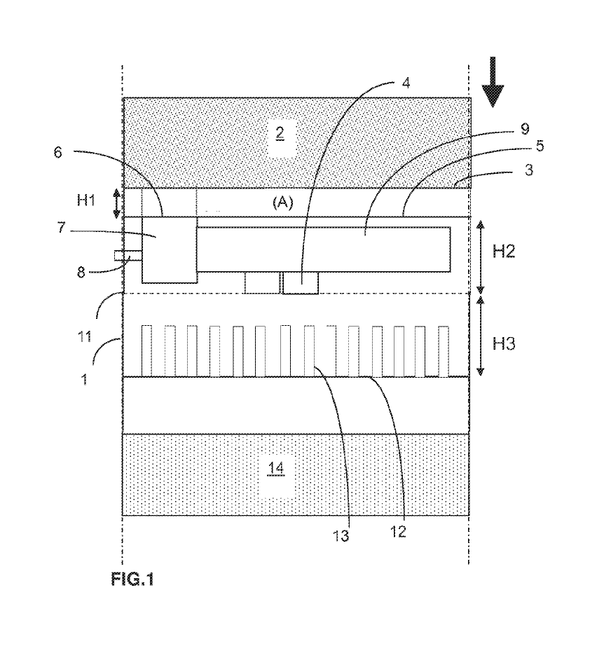

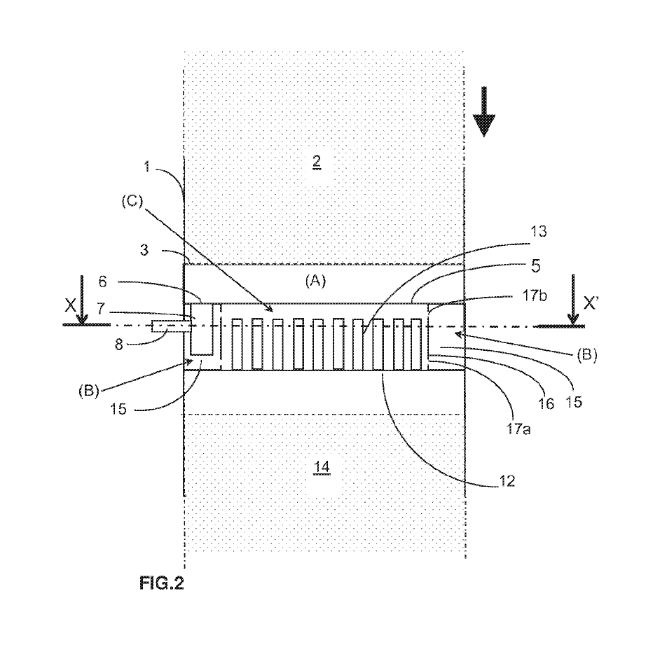

In order better to understand the invention the description set forth hereinafter by way of example of application thereof concerns a mixing and distribution device used in a reactor adapted to hydrotreatment reaction. The description relating to FIG. 1 relates to a mixing and distribution device according to the prior art, the description relating to FIGS. 2 to 7 relates to a mixing and distribution device according to the invention. FIGS. 2 and 7 again involve certain elements from FIG. 1; the references in FIGS. 2 to 7 which are identical to those in FIG. 1 denote the same elements. It will be appreciated that, without departing from the scope of the invention, the device according to the invention can be used in any reactor or device and in any field in which it is desirable to obtain a good mixing effect, matter and/or thermal, and a good distribution of fluids.

FIG. 1 illustrates a mixing and distribution device according to the prior art disposed in a reactor 1 of elongate shape along a substantially vertical axis, in which at least one reaction fluid is circulated from the top downwardly, through two catalyst beds 2 and 14. The reaction fluid can be a gas (or a mixture of gases) or a liquid (or a mixture of liquids) or a mixture containing liquid and gas. The mixing and distribution device is disposed below the catalyst bed 2 with respect to the flow of reaction fluid in the enclosure 1. A support grid 3 makes it possible to carry the catalyst bed 2 in such a way as to free a collection space (A) below same (also referred to herein as the collection zone (A)). The height H1 of the collection space (A) is typically between 10 and 300 mm. That collection space or zone (A) makes it possible to collect the flow issuing from the catalyst bed 2 at the level of the collection means 5. The collection means 5, also referred to as a baffle, is a solid plate member which is only open at one location 6 to drain the flow of fluid towards the annular mixing chamber 9. The reaction fluid issuing from the bed 2 is thus compelled in the collection zone (A) to pass through the vertical collection conduit 7 which communicates with the opening 6. A quench fluid is injected into the collection conduit 7 by way of an injection conduit 8. The quench fluid can be liquid or gas or a mixture containing liquid or gas. The chamber 9 is connected by its inlet end to the collection conduit 7. The quench fluid and the reaction fluid issuing from the upper bed 2 are thus forced to involve the chamber 9 in which they mix while being subjected to a rotational flow. At the outlet from that chamber the mixture of the fluids flows over the pre-distribution plate 11 disposed downstream of the mixing chamber 9 in the direction of flow of the fluids. Typically the height H2 (see FIG. 1) between the collection means 5 and the pre-distribution plate member 11 is between 300 and 600 mm. The mixing chamber 9 is positioned at the periphery of the reactor. The gas and liquid phases of the mixture are separated on the perforated plate member 11 which is provided with one or more central chimneys 4 configured to permit the passage of gas. The liquid passes by way of the perforations of the plate member to form a flow of showerhead or rain type. The function of the perforated plate member 11 is to distribute the flow issuing from the mixing chamber 9 to feed the distribution plate 12 in relatively balanced manner, which distribution plate 12 is positioned downstream of the pre-distribution plate member in the direction of flow of the fluids. Typically the height H3 (see FIG. 1) measured between the pre-distribution plate member 11 and the distribution plate 12 is between 100 and 700 mm. The distribution plate 12 comprises chimneys 13, the function of which is to redistribute the gas and liquid phases at the entry to the catalyst bed 14 disposed downstream of the distribution plate 12.

The mixing and distribution device according to the prior art therefore comprises a mixing zone and a distribution zone which are positioned one above the other, in staged relationship. Mixing of the fluids is effected over a height H2 and distribution of the fluids is effected over a height H3. Consequently the total size H in the enclosure 1 of a mixing and distribution device according to the prior art is equal to H1+H2+H3 (see FIG. 1).

The applicant has developed a novel fluid mixing and distribution device, which is more compact than that described hereinbefore, and which affords good mixing of the phases and good distribution over the catalyst bed disposed below such devices.

FIG. 2 shows a mixing and distribution device according to the invention disposed in a reactor 1 of elongate shape along a substantially vertical axis, in which at least one reaction fluid is circulated from the top downwardly through at least one catalyst bed 2. The device according to the invention is disposed below the catalyst bed 2, in relation to the flow of reaction fluid in the enclosure 1. A support grid 2 makes it possible to support the catalyst bed 2 in such a way as to afford a collection zone (A) disposed below the catalyst bed 2. The collection zone (A) is necessary to permit draining of the reaction fluid to a collection conduit 7 (which will be described hereinafter). The reaction fluid which flows away is for example composed of a gaseous phase and a liquid phase.

More particularly the reaction fluid passing through the catalyst bed 2 at an upstream location is collected by a collection means 5 (referred to herein also as the collection baffle) which is substantially horizontal, leading to a substantially vertical collection conduit 7 disposed below the collection zone (A) at the level of a zone referred to as the mixing zone (B) (as shown in FIG. 2), that is to say at the level of the collection zone (A) (not shown in the Figures). The terms substantially vertical and substantially horizontal are used to denote in accordance with the present invention a variation of a plane in relation to the vertical and horizontal respectively through an angle θ of between ±5 degrees. The collection means 5 is formed by a solid plate member disposed in the plane perpendicular to the longitudinal axis of the enclosure under the support grid 3 for the catalyst bed 2. The plate member of the collection means 5 extends radially over the entire surface area of the reactor 1. At its end it comprises an opening 6 to which the collection conduit 7 is connected. The collection means 5 makes it possible to collect the flow of reaction fluid coming from the catalytic bed 2 upstream and to direct it towards the collection conduit 7. The collection means 5 is spaced from the support grid 3 of the catalyst bed 2 by a height H′1 (FIG. 4). The height H′1 is so selected as to limit the pressure drop upon collection of the fluid flowing from the catalyst bed 2 and to limit the reserve height, that is to say the height formed by the liquid accumulated in the collection means 5. The reserve height does not modify drainage of the reaction fluid towards the collection conduit 7, nor the flow thereof in that conduit, nor the flow thereof through the upper catalytic bed 2. When the collection conduit 7 and the injection means 8 are disposed at the level of the mixing zone (B) the height H′1 is between 10 and 200 mm, preferably between 30 and 150 mm, still more preferably between 40 and 100 mm. Thus the reaction fluid from the bed 2 is forced in the collection zone (A) to pass by way of the vertical collection conduit 7. When the collection conduit 7 and the injection means 8 are disposed at the level of the collection zone (A) the height H′1 is between 10 and 400 mm, preferably between 30 and 300 mm and still more preferably between 50 and 250 mm.

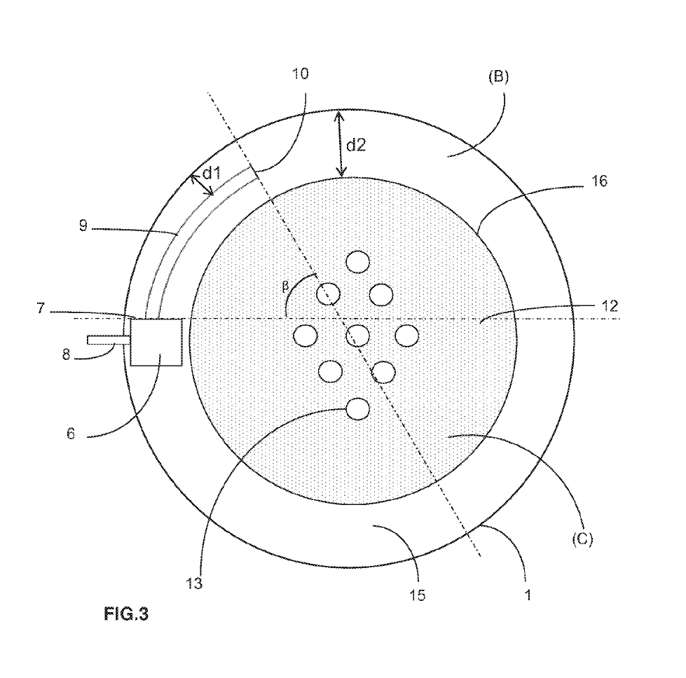

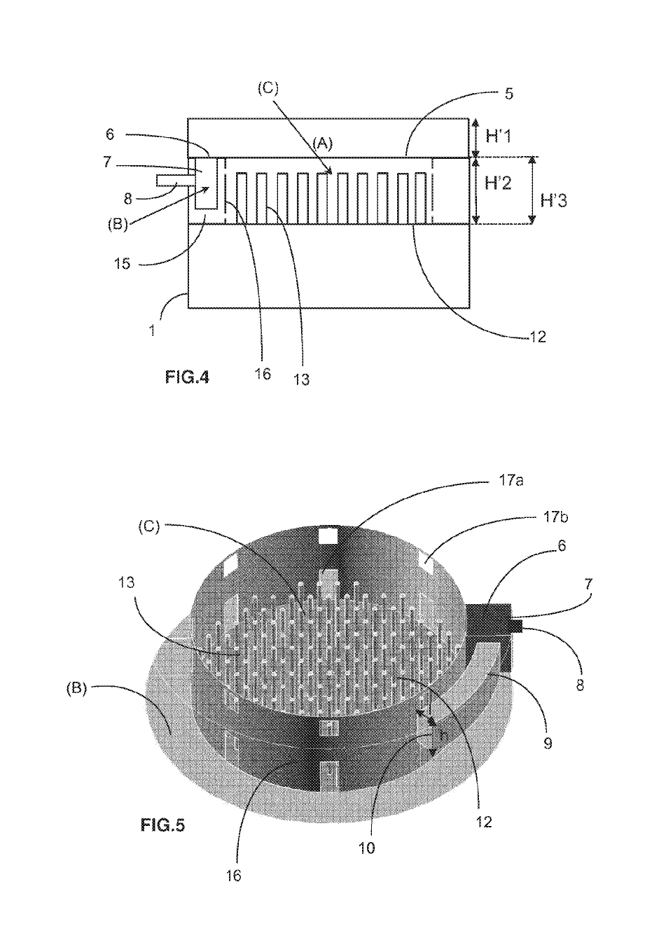

Disposed below the collection zone (A) is a mixing zone (B) and a distribution zone (C). The mixing zone (B) comprises a mixing chamber 9 (see FIGS. 3 and 5) disposed downstream of the collection means 5 in the direction of flow of the fluids. The mixing chamber 9 comprises an inlet end directly connected to the collection conduit 7 and an outlet end 10 for discharge of the fluids (see FIGS. 3 and 5). The technical considerations relating to the collection conduit 7 and the injection means 8 are identical to those of the mixing and distribution device according to the prior art. As for the distribution zone (C) it comprises a distribution plate 12 supporting a plurality of chimneys 13.

A characteristic of the present invention involves placement of the mixing zone (B) at the same level as the distribution zone (C), the mixing and distribution zones (B and C) being delimited by at least one annular wall 16 comprising at least one lateral passage section adapted to the passage of the fluids from said mixing zone (B) to said distribution zone (C).

In a first variant of the invention the mixing zone (B) is positioned in an annular enclosure 15 comprising the annular wall 16, at the periphery of the enclosure of the reactor, arranged in concentric relationship with the enclosure of the reactor, and internally delimiting the distribution zone (C) by way of the annular wall 16, preferably substantially cylindrical, which annular wall comprises at least one lateral passage section 17a or 17b adapted for the passage of the fluids from the mixing zone (B) to the distribution zone (C). Preferably the annular wall 16 comprises at least two lateral passage sections 17a and 17b.

The outlet end 10 of the mixing chamber 9 opens into the annular enclosure 15 (see FIG. 3 or 5). The configuration of the mixing chamber 9 in the mixing zone (B) permits a tangential flow of the mixture of fluids both in the mixing chamber itself and in the annular enclosure 15, which tangential flow makes it possible to optimise the effectiveness of the mixing action. Mixing as between the reaction fluid and the quench fluid continues to be effected at the level of the annular enclosure 15. The dimensions of the annular enclosure 15 are so selected that they permit rotation of the mixture of the fluids in the annular enclosure 15 before passing into the distribution zone (C). According to the invention the height H′2 of the annular enclosure 15 is between 200 and 800 mm, preferably between 300 and 700 mm and still more preferably between 300 and 600 mm.

In a particular embodiment (not shown in the Figures) the annular enclosure 15 can be sectioned, that is to say that enclosure comprises two ends. In this embodiment the length of the annular enclosure 15 as is defined by the angle formed by the planes passing through the two ends of the enclosure can be between 270 and 360 degrees, preferably between 315 and 360 degrees.

The annular enclosure 15 internally surrounds the distribution zone (C) over a height H′3 comprising a distribution plate 12 (also referred to herein as a distributor plate or a distribution plate member) and a plurality of chimneys 13. More precisely the chimneys are open at their upper end by way of an upper opening and along their lateral wall have a series of lateral orifices (not shown in the Figures) intended for the separate flow of the liquid phase (by way of the orifices) and the gaseous phase (by way of the upper opening) in the interior of the chimneys so as to provide for intimate mixing thereof in the interior of the chimneys. The shape of the lateral orifices may vary greatly, being generally circular or rectangular, those orifices preferably being distributed over each of the chimneys at a plurality of substantially identical levels from one chimney to the other, generally at least one level and preferably from two to ten levels so as to permit the establishment of an interface which is as regular as possible between the gaseous phase and the liquid phase.

In comparison with the mixing and distribution device of the prior art the mixing and distribution device according to the invention does not comprise any pre-distribution plate member 11 provided with chimneys. In fact, in accordance with an essential aspect of the device according to the invention, the mixing chamber 9 is positioned at the periphery of the reactor 1 in the mixing zone (B) comprised in an annular enclosure 15 disposed at the same level as the distribution zone (C). Mixing and distribution of the fluids are no longer implemented at two different levels. The mixing and distribution device according to the invention is therefore significantly more compact in comparison with those known in the prior art. In comparison with the device according to the prior art as shown in FIG. 1 the overall bulk of the mixing and distribution device is H=H′1+H′2=H′1+H′3 (see FIG. 4), H′2 (or H′3) corresponding to the height of the annular enclosure 15.

Referring now to FIGS. 3 to 5 illustrating a mixing and distribution device according to the first variant of the invention the annular enclosure 15 is separated from the distribution zone (C) by an annular wall 16 which is concentric with the enclosure of the reactor and is preferably substantially cylindrical, comprising a plurality of lateral passage sections 17a and 17b permitting the passage of the liquid and the gas issuing from the mixing chamber 9 and flowing in the annular enclosure 15 from the mixing zone (B) to the distribution zone (C). The lateral passage sections 17a/17b may be inconsequentially either in the form of an orifice or a slot.

Advantageously the annular wall 16 separating the mixing zone (B) from the distribution zone (C) is disposed at a spacing d2 from the enclosure of the reactor 1, the spacing d2 being between 2% and 20% of the diameter of the reactor, preferably between 3% and 15% of the diameter of the reactor, still more preferably between 6% and 12% of the diameter of the reactor.

Thus the annular enclosure 15 is delimited on the outward side by the enclosure of the reactor 1 and on the inward side by the annular wall 16, the annular wall 16 being disposed in the space between the enclosure of the reactor 1 and the chimneys 13 which are disposed more outwardly, that is to say the chimneys 13 being distributed substantially on the circle of larger diameter.

Preferably the annular wall 16 comprises a plurality of lateral passage sections 17a and 17b distributed over at least one level, preferably at least two levels. Referring to FIG. 5 the lateral passage sections 17a permit in particular a flow of liquid from the mixing zone (B) to the distribution zone (C) and the lateral passage sections 17b permit in particular a flow of gas from the mixing zone (B) to the distribution zone (C). In the distribution zone (C) of the device according to the invention the gaseous and/or liquid phases of the mixture pass into the distribution zone (C) by means of the lateral passage sections 17a and 17b disposed on the annular wall 16. The distribution plate 12 extends radially over the entire distribution zone (C) of the device and is disposed in the plane perpendicular to the longitudinal axis of the enclosure 1 of the reactor. The distribution plate 12 makes it possible to optimise distribution of the cooled reaction fluid on the catalyst bed 14 disposed downstream of the distribution plate.

Referring now to FIGS. 3 and 5 the mixing chamber 9 is of a substantially annular shape and can be of a parallelogram-shaped or circular section. The term parallelogram-shaped section is used to denote any section having four sides of which the opposite sides of that section are parallel two by two, for example a parallelogram section may be a rectangular section (see FIG. 3), a square section or a rhombus section. The term circular section is used to denote a section in the form of a circle or an oval. Irrespective of the shape of the section of the mixing chamber 9 the height or the diameter of the chamber will be so selected as to limit the pressure drop to the maximum extent and to limit the spatial bulk in the reactor.

The length of the mixing chamber 9 is defined by the angle formed by the planes passing through the two ends of the chamber (represented by the angle β in FIG. 3). The length of the mixing chamber is between 0 and 270 degrees. Preferably the length of the chamber is between 30 and 200 degrees, more preferably between 90 and 180 degrees. Advantageously the mixing chamber 9 is disposed at a spacing d1 from the enclosure of the reactor 1, which spacing d1 is between 5 and 300 mm, preferably between 5 and 150 mm (see FIG. 3).

When the section of the mixing chamber is a parallelogram-shaped section the dimensions of the height section “h” and the width section “I” are such that the ratio between the height “h” and the width “l” is between 0.2 and 5.0, preferably between 0.5 and 2.0 (see FIG. 5).

The height “h” of the mixing chamber is selected to limit the pressure drop to the maximum extent and to limit the spatial bulk in the reactor. In fact the pressure drop of the mixing device according to the invention depends on the section of the mixing chamber.

When the section of the mixing chamber is a circular section (a circle) the diameter “d” of the mixing chamber is between 0.05 and 0.8 m, more preferably between 0.1 and 0.5 m, still more preferably between 0.15 and 0.5 m and still more preferably between 0.15 and 0.4 m. The pressure drop of the device according to the invention depends on the diameter in the mixing chamber.

The pressure drop follows a classic pressure drop law and can be defined by the following equation:

$$Δ P = \frac{1}{2} {ρ}_{m} {V}_{m}^{2} 𝒳$$

wherein ΔP is the pressure drop, ρₘ is the mean density of the gas+liquid mixture in the mixing chamber, Vₘ is the mean speed of the gas+liquid mixture and χ is the pressure drop coefficient associated with the mixing device. The preferred pressure drop range in terms of dimensioning of industrial devices is 0.05 bar <ΔPₘₐₓ<0.5 bar (1 bar=10⁵ Pa), preferably 0.1 bar <ΔPₘₐₓ<0.25 bar.

In a particular embodiment of the invention when the section of the mixing chamber is a parallelogram-shaped section the outlet 10 of the mixing chamber 9 is of a height “h” and/or a width “l′” less than the height “h” and/or the width “l” of the section of the mixing chamber 9 (except for the outlet) in order further to improve the homogeneity of the mixture. The ratio h′/h and/or l′/l is between 0.5 and 1, preferably between 0.7 and 1. In another particular embodiment of the invention when the section of the mixing chamber is a circular section the outlet 10 of the mixing chamber is of a diameter “d′” smaller than the diameter “d” of the section of the mixing chamber 9 (except for the outlet) in order further to improve the homogeneity of the mixture. The ratio d′/d is between 0.5 and 1, preferably between 0.7 and 1.

Advantageously the mixing chamber 9 may comprise at least one deflection means (not shown in the Figures) on at least one of the internal walls of the mixing chamber. The presence of at least one deflection means for the mixture of fluids passing through that chamber makes it possible to increase the exchange area between the two phases and therefore the efficiency in terms of the transfers of heat and matter between the liquid phase and the gaseous phase passing through the chamber. The deflection means may be in a plurality of geometrical shapes making it possible to increase the effectiveness of the mixing chamber, it being appreciated that said shapes permit at least partial deflection in the trajectory of the mixture of fluids passing through the chamber. For example the deflection means may be in the form of a baffle arrangement, of triangular, square, rectangular, or ovoidal section or any other sectional shape. The deflection means may also be in the form of one or more blades or else one or more vanes which are fixed.

In a particular embodiment of the invention two mixing chambers 9 can be positioned in the mixing zone (B) in order to reduce the height “h” or the diameter “d” of the mixing chambers, while ensuring good mixing of the fluids and good temperature homogeneity. Preferably the two mixing chambers are diametrally opposite in the enclosure of the reactor. For each mixing chamber 9, a collection conduit 9 and an injection means 8 are associated therewith.

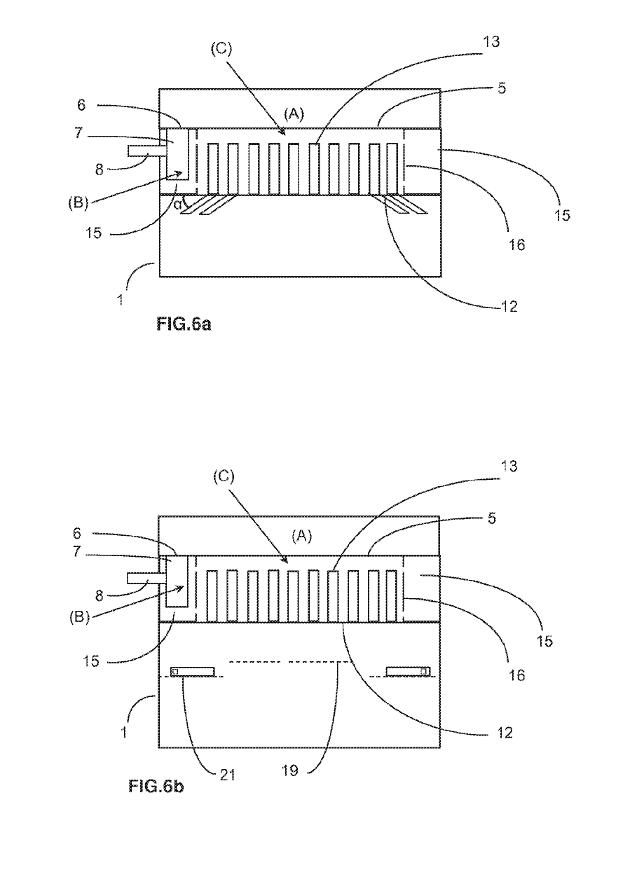

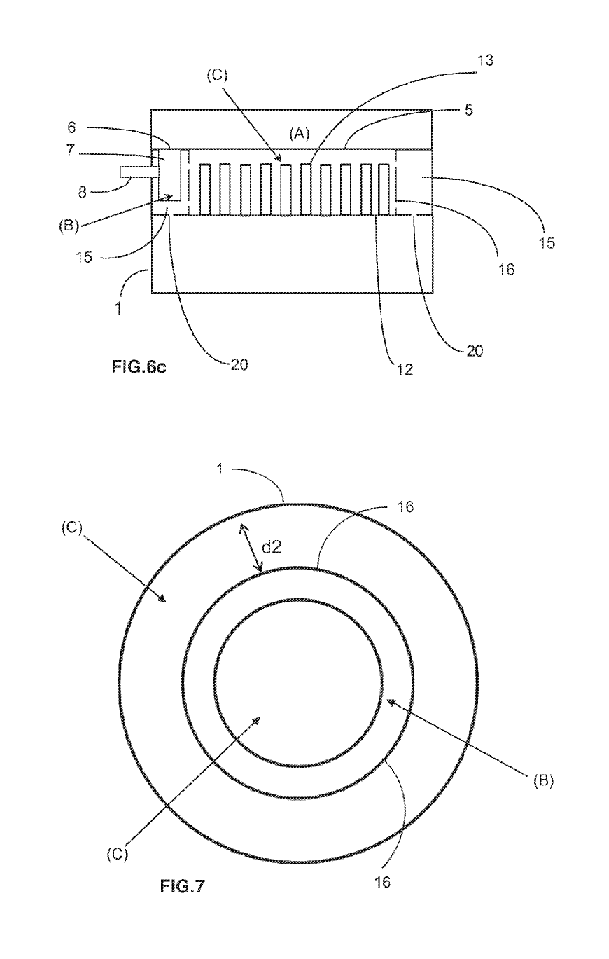

Below the distribution plate 12 a dispersion system may be positioned in such a way as to distribute the fluids uniformly over the catalyst bed 14 disposed downstream of the system. The dispersion system comprises one or a plurality of dispersion devices 19 (see FIG. 6b) which can be associated with each chimney 13, which can be in common with a plurality of chimneys 13, or which again can be in common with the assembly of the chimneys 13 of the distribution plate 12. Each dispersion device 19 is of a substantially planar and horizontal geometry but can be of a perimeter of any shape whatever. Moreover each dispersion device 19 can be disposed at a different height. Advantageously the dispersion device is in the form of grids and may possibly comprise deflectors.

The distance separating the dispersion system from the bed of granular solids which is disposed immediately below same is so selected as to preserve the mixing state of the gaseous and liquid phases as much as possible as it is on issuing from the chimneys 13.

Preferably the spacing between the distribution plate 12 and the catalyst bed 14 disposed below the distribution plate is between 50 and 400 mm, preferably between 100 and 300 mm.

The spacing between the distribution plate 12 and the dispersion device 19 is between 0 and 400 mm, preferably between 0 and 300 mm.

In a particular embodiment the distribution plate 12 is placed on the dispersion device 19.

According to the invention the distribution zone (C) comprising the distribution plate 12 and the chimneys 13 does not extend radially over the entire section of the enclosure of the reactor as the mixing zone (B) comprising the mixing chamber 9 internally surrounds the distribution zone (C). Consequently, to remedy the absence of the distribution plate 12 and chimneys 13 at the periphery of the reactor, that is to say the zone disposed below the annular enclosure 15, a plurality of deflection means for the fluids can be envisaged for distributing the fluids homogeneously above the catalyst bed 14 disposed downstream of the mixing and distribution device, in the direction of the flow of fluids, and more particularly in the zone disposed below the mixing zone (B).

In a first embodiment and as illustrated in FIG. 6a at least one of the chimneys 13 disposed at the periphery of the distribution zone (C), that is to say which is in the proximity of the annular wall 16, is prolonged downwardly below the distribution plate member 12 and is angled in such a way as to be adapted to partially distribute the flow of mixture of fluids at the periphery of the reactor 1. More particularly the angling angle α taken between the longitudinal axis of the prolongation of the chimneys 13 below the distribution plate member 12 and the plane perpendicular to the longitudinal axis of the enclosure is between 0 and 90 degrees, preferably between 10 and 50 degrees and still more preferably between 30 and 45 degrees. In that way the fluids are distributed radially over the entire surface area of the enclosure of the reactor.

In a second embodiment and as illustrated in FIG. 6b the dispersive systems 19 are in the form of grids positioned below the mixing zone (B) and the distribution zone (C). The grids further comprise a guide system 21 in the form of at least one guide ramp 21 which makes it possible to collect at least a part of the flow of liquid issuing from the distribution zone (C) and to pass it to the periphery of the enclosure of the reactor 1 in order to distribute the fluids radially over the entire surface area of the enclosure of the reactor above the second catalyst bed 14. The guide ramp can involve a profile in the form of a U or a V in order to direct the flow of liquid received to the periphery of the reactor and may possibly comprise one or more perforations to permit the flow of liquid to flow below the grids.

In a third embodiment and as illustrated in FIG. 6c the annular enclosure 15 of the mixing zone (B) comprises at least one opening (perforation) 20, and preferably comprises a plurality of openings 20, making it possible to collect at least partially the fluids from the mixing chamber 9 opening into the annular enclosure 15, thus making it possible to partially distribute the fluids at the periphery of the enclosure of the reactor. The size and shape of the openings are so selected that they make it possible to collect only a minor part of the fluids in the annular enclosure 15. The major part of the fluids pass through the lateral passage section or sections 17a and/or 17b.

It will be appreciated that the variant of the invention set forth hereinbefore is only an illustration of the invention and is in no way limiting. Other variants of the mixing and distribution device may be envisaged.

For example in a variant of the invention the distribution zone (C) is positioned at the periphery of the enclosure of the reactor and internally delimits the mixing zone (B) by means of an annular wall 16, preferably substantially cylindrical, the annular wall 16 comprising at least one lateral passage section 17a or 17b adapted for the passage of the fluids from the mixing zone (B) to the distribution zone (C).

In another variant of the invention (see FIG. 7) the mixing zone (B) is comprised in an annular enclosure 15 positioned in the distribution zone (C), the position of the annular enclosure 15 being such that it forms two distribution zones (C), the mixing zone being delimited by two annular walls 16 each comprising at least one lateral passage section adapted for the passage of the fluids from the mixing zone (B) to the distribution zones (C). In this variant the spacing “d2” may be interpreted as being between the enclosure of the reactor and the wall 16 closest to the enclosure of the reactor, that is to say the annular wall of largest diameter (see FIG. 7).

In comparison with the devices described in the prior art and still more particularly in comparison with the device disclosed in FR 2 952 835 the mixing and distribution device according to the invention has the following advantages:
increased compactness by virtue of integration at the same height of the fluid mixing and distribution zones; and
good thermal efficiency and good mixing efficiency by virtue of the rotational flow in the mixing chamber, in the annular enclosure, and over or at the level of the distribution plate.

### Examples

In the following examples the device which is not according to the invention (device A) is compared to a device according to the invention (device B). For the two devices, it is considered that the heights H1 and H′1 of the collection space (A) are identical and are equal to 120 mm. In the same way the height between the distribution plate 12 and the height of the second catalytic bed 14 is fixed at 400 mm. The comparisons between those two devices are based on their compactness in a catalytic reactor. These examples are set forth herein by way of illustration and do not in any way limit the scope of the invention.

### Device a (not According to the Invention):

For a reactor diameter of 5 m the space occupied by a conventional mixing device as disclosed in FR 2 952 835 A1, between the upper end of the collection conduit 7 and the pre-distribution plate 11, is about 650 mm. The space occupied is about 950 mm by adding the size of the distribution plate 12 disposed below the pre-distribution plate member 11 (corresponding to a height H3=300 mm).

Thus the total size of a conventional mixing and distribution device measured between the bottom of the first catalytic bed 2 and the top of the second catalytic bed 14 is 120+950+400=1470 mm.

### Device B (According to the Invention):

For a reactor diameter of 5 m the height H′2 of the annular enclosure 15 of the device according to the invention is 600 mm and the spacing “d2” between the wall 16 of the annular enclosure 15 and the enclosure of the reactor is 350 mm, permitting rotation of the fluids in the mixing zone (B) before passing into the distribution zone (C). Thus the total space occupied by the mixing and distribution device according to the invention measured between the bottom of the first catalytic bed 2 and the top of the second catalytic bed 14 is 120+600+400=1120 mm.

Thus by way of comparison the device according to the invention permits a gain in space of 24% with respect to the device A. The space gained by virtue of the compactness of the device according to the invention in relation to the device of the prior art can thus be used for the catalyst beds. Accordingly the device according to the invention also makes it possible to enhance the performance levels of a reactor by an increase in the amount of catalyst in the catalytic beds.

1. A device for mixing and distributing fluids for a downward flow catalytic reactor, said device comprising:
at least one collection zone (A) comprising at least one collection means (5);
at least one substantially vertical collection conduit (7) adapted to receive a reaction fluid collected by said collection means (5) and at least one injection means (8) opening into said collection conduit (7) to inject a quench fluid;
at least one mixing zone (B) disposed downstream of the collection means (5) in the direction of flow of the fluids, said mixing zone (B) comprising at least one mixing chamber (9) connected to said collection conduit (7) and an outlet end (10) for discharge of the fluids; and
at least one distribution zone (C) disposed downstream of said mixing zone (B) in the direction of flow of the fluids comprising a distribution plate (12) supporting a plurality of chimneys;
characterised in that said mixing zone (B) is disposed at the same level as the distribution one (C), said mixing zone (B) and said distribution zone (C) being delimited by at least one annular wall (16) comprising at least one lateral passage section (17a, 17b) adapted for the passage of the fluids from said mixing zone (B) to said distribution zone (C).

2. A device according to claim 1 characterised in that said mixing zone (B) is included in an annular enclosure (15) comprising said annular wall (16).

3. A device according to claim 2 characterised in that said annular wall (16) internally delimits said distribution zone (C).

4. A device according to claim 1 characterised in that said annular wall (16) is positioned at a spacing d2 from the enclosure of the reactor, the spacing d2 varying from 2% to 20% of the diameter of the reactor.

5. A device according to claim 1 characterised in that said mixing chamber (9) is positioned at a spacing d1 from the enclosure of the reactor, the spacing d1 being between 5 and 30 mm.

6. A device according to claim 2 characterised in that the height of said annular enclosure (15) is between 200 and 800 mm.

7. A device according to claim 1 characterised in that the annular wall (16) comprises a plurality of lateral passage sections (17a, 17b) distributed on at least two levels.

8. A device according to claim 1 characterised in that said annular wall (16) is substantially cylindrical.

9. A device according to claim 1 characterised in that the section of said mixing chamber (9) is of a parallelogram configuration and has a ratio between the height “h” of the section and the width “l” of said section of between 0.2 and 5.0.

10. A device according to claim 1 characterised in that said mixing zone (B) comprises two mixing chambers (9) which are in diametrally opposite relationship in said mixing zone (B).

11. A device according to claim 1 characterised in that the chimneys (13) which are disposed at the periphery of said distribution zone (C) are prolonged below the distribution plate (12) and are angled, the angling angle α between the longitudinal axis of prolongation of the chimneys (13) below said distribution chamber (12) and the plane perpendicular to the longitudinal axis of the enclosure being between 0 and 90 degrees.

12. A device according to claim 1 characterised in that it further comprises a dispersive system disposed below said distribution plate (12), said dispersive system comprising at least one dispersion device (19).

13. A device according to claim 12 characterised in that said dispersion device (19) is a grid comprising at least one guide system (21) adapted to collect and transport at least a part of the flow of liquid issuing from said distribution zone (C).

14. A device according to claim 1 characterised in that said mixing and distribution zones (B and C) are delimited by two annular walls (16) each comprising at least one lateral passage section (17a, 17b) adapted for the passage of the fluids from said mixing zone (B) to said distribution zone (C).

15. A downward flow catalytic reactor comprising an enclosure (1) enclosing at least two fixed catalyst beds (2, 14) separated by an intermediate zone comprising a fluid mixing and distribution device according to claim 1.
